(19) United States
(12) Patent Application Publication
(10) Pub. No.: US 2007/0136943 A1
(43) Pub. Date: Jun. 21, 2007

(54) Water jet mechanism for whirlpool effect in pedicures or other applications

(76) Inventor: Christopher L. Long, Owings Mills, MD (US)

Correspondence Address: ARMSTRONG, KRATZ, QUINTOS, HANSON & BROOKS, LLP;Intellectual Property Law Offices, Suite 220, 502 Washington Avenue, Towson, MD, 21204, US

(21) Appl. No.: 11/312,907

(22) Filed: Dec. 20, 2005

(51) Int. Cl. A47K 3/022; A61H 35/00; E03C 1/00

(52) U.S. Cl. 4/622

(57) ABSTRACT

A whirlpool foot bath for a pedicure chair having a housing with a removable cap and a rotor and stator magnetic motor within the housing. Water in the bath is circulated through an inlet in the cap and out through at least one outlet in the cap. A method of use is described.

### BACKGROUND OF THE INVENTION

1. Field of the Invention

The present invention relates to a water jet mechanism and method of use in a pedicure and more particularly, to a motor having a stator with magnetically-retained rotor in a housing having a cap.

2. Description of Related Art

It is known to have a pedicure chair with a basin for bathing the feet of a person (U.S. Pat. No. D454,705 to Long). These types of pedicure chairs have a pipe system to introduce water into, and remove water from, the basin. The water is circulated by a conventional motor-driven, shaft mounted, fan. There is frequently water leakage around the shaft requiring maintenance. Also, the pipe system is subject to accumulation of dirt, mold and bacteria and is very difficult to clean and sterilize after use by each customer. There is the possibility of health concerns, safety and anxiety of customers.

A water circulation unit having a stator which creates a rotating magnetic field and is separated from the water by a magnetically permeable wall and a rotor on the opposite side of the wall is disclosed in U.S. Pat. No. 5,941,225 to Laing. This unit is part of a hot water distribution system which circulates cooled down hot water away from a spigot and brings in hot water such that hot water is always immediately available at the spigot.

There is a need for a circulating system for water in a pedicure bath which provides adequate movement of the water and which can be cleaned and sterilized rapidly and effectively to provide for the health and anxiety of persons using the pedicure bath.

### SUMMARY OF THE INVENTION

It is an object of the invention to provide a system for circulating water in a bath used in a pedicure, a jacuzzi and a whirlpool bath, the system being rapidly and easily cleaned and sanitized.

It is a further object of the invention to provide a method of preparing for use a bath used in a pedicure, a jacuzzi and a whirlpool bath.

In accordance with the teachings of the present invention, there is disclosed an improvement 10 to a pedicure chair having a whirlpool foot bath provided with a basin, wherein water is continually ejected through respective first pipes into the basin and is thereafter withdrawn therefrom through respective second pipes and wherein mold or bacteria may tend to accumulate in the pipes, such that cleaning or sterilizing the pipes after each customer becomes difficult and time consuming, and such that customer health problems or anxieties occur. The improvement has a means for filling the basin with fresh water initially, at least one induction motor and combination pump mounted in a housing on the basin and having a removable cap provided with at least one inlet opening and at least one outlet opening for communication with the basin. In this manner, the fresh water is sucked out of the basin through the inlet opening and thereafter is discharged out of the at least one outlet opening for continually recirculating the water in the basin and thereby creating a whirlpool action therein. The induction motor and combination pump has a stator and further has a magnetically-retained rotor.

After each customer, the cap may be removed, the rotor manually pulled away from the stator, and the pump quickly and conveniently cleaned or sterilized. Thereafter, the magnetically-retained motor and the cap may be easily replaced, thereby saving considerable time between customers, substantially improving customer safety, and removing customer anxieties and health concerns.

In further accordance with the teachings of the present invention, there is disclosed a jet pump mounted in a basin of a pedicure chair, jacuzzi or whirlpool bath wherein water is circulated. The jet pump has a housing having an externally accessible removable cap. The cap has an outer surface and an inner surface. An annular rim is formed on the outer surface. A raised ring is formed in the inner surface separated from the annular rim by a trepan, a central portion being defined within the raised ring. The central portion has a water inlet formed therein. The raised ring has a plurality of discharge ports formed therein, the discharge ports extending through the cap. A motor having a stator and a magnetically coupled rotor is disposed within the housing, the rotor being received within the central portion of the cap. When the motor is activated, the rotor rotates drawing water through the water inlet and expelling the water radially across the trepan. The water circulating within the cap is directed axially outwardly through the plurality of discharge ports.

In still further accordance with the teachings of the present invention, there is disclosed a method of preparing a pedicure bath for use and of using the bath. A chair is provided having a whirlpool foot bath with a basin in which a customer's feet are disposed. The basin has at least one pump therein. The at least one pump has a housing and a removable cap. The cap has at least one inlet opening and at least one outlet opening formed therein. A motor is received in the housing, the motor having a stator and a magnetically retained rotor. The rotor may be manually lifted out of the housing without the use of tools, wherein when the motor is activated, water in the basin is drawn into the at least one inlet opening and discharged vigorously from the at least one outlet creating a whirlpool action and circulating water in the basin. A predetermined amount of water is placed in the basin. A customer is seated in the chair wherein the customer's feet are aligned with the at least one pump. The pump is activated for a predetermined time. The customer's feet are removed from 5 the basin and the water is emptied from the basin. The cap is removed from the housing of the pump and the rotor is manually removed. The cap and rotor and stator of the motor are cleaned and sterilized. The rotor and the cap are replaced. The basin is cleaned and sterilized. In this manner, the foot bath is prepared for the next customer in a safe, sanitary and rapid manner.

These and other objects of the present invention will become apparent from a reading of the following specification taken in conjunction with the enclosed drawings.

### BRIEF DESCRIPTION OF THE DRAWINGS

FIG. 1 is a perspective view of a person seated in a pedicure chair with their feet in the basin.

FIG. 2 is a top view of the basin showing the person's feet in the bath opposite from a water pump.

FIG. 3 is an exploded view of the present invention.

FIG. 4 is a side view of the threaded housing on which are mounted a screw ring and ring seals.

FIG. 5 is a cross section view showing the mounting of the housing in the basin.

FIG. 6 is a perspective view of the rotor separated from the stator.

FIG. 7 is a perspective view of the outer surface of the cap to the housing.

FIG. 8 is a perspective view of the inner surface of the cap of the housing.

FIG. 9 is a cross-section view taken across the lines 9-9 of FIG. 8.

FIG. 10 is a plan view of the inner surface of the cap of the housing.

FIG. 11 is a side elevation view showing the rotor in rotation and the movement of water radially from the rotor.

FIG. 12 is a diagram showing the movement of water within the cap.

FIG. 13 is a perspective view showing removal of the back ring to access the motor for replacement.

FIG. 14 is a flowchart showing the method of preparing, cleaning and using the pedicure bath.

FIG. 15 is a perspective view showing a plurality of extra rotors and caps in a sterilizing solution to be used to rapidly prepare the basin for the next customer.

FIG. 16 is a flowchart showing the preparation and use of the pedicure chair incorporating the present invention.

### DESCRIPTION OF THE PREFERRED EMBODIMENTS

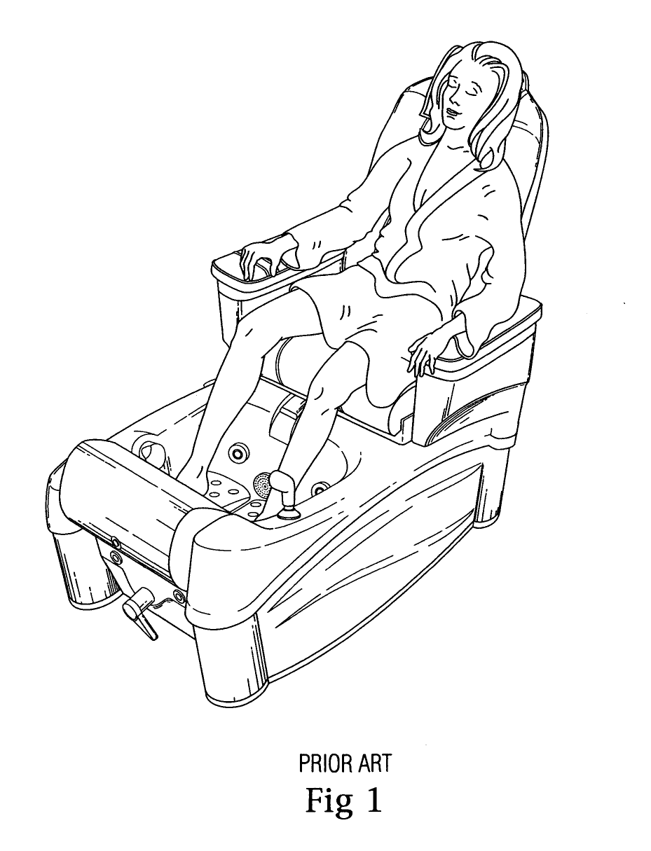

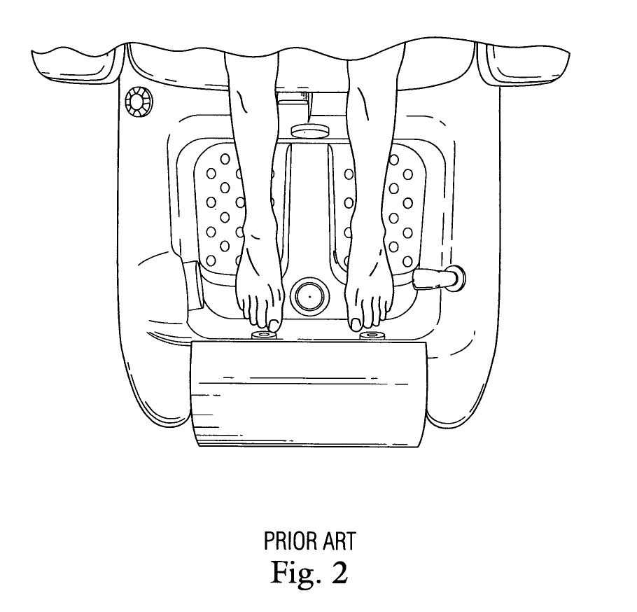

As shown in FIGS. 1 and 2, persons receiving a pedicure are usually seated in a pedicure chair 10 which has a basin 12 in which the person's feet are placed. Water is circulated in the basin 12 and is directed at the person's feet.

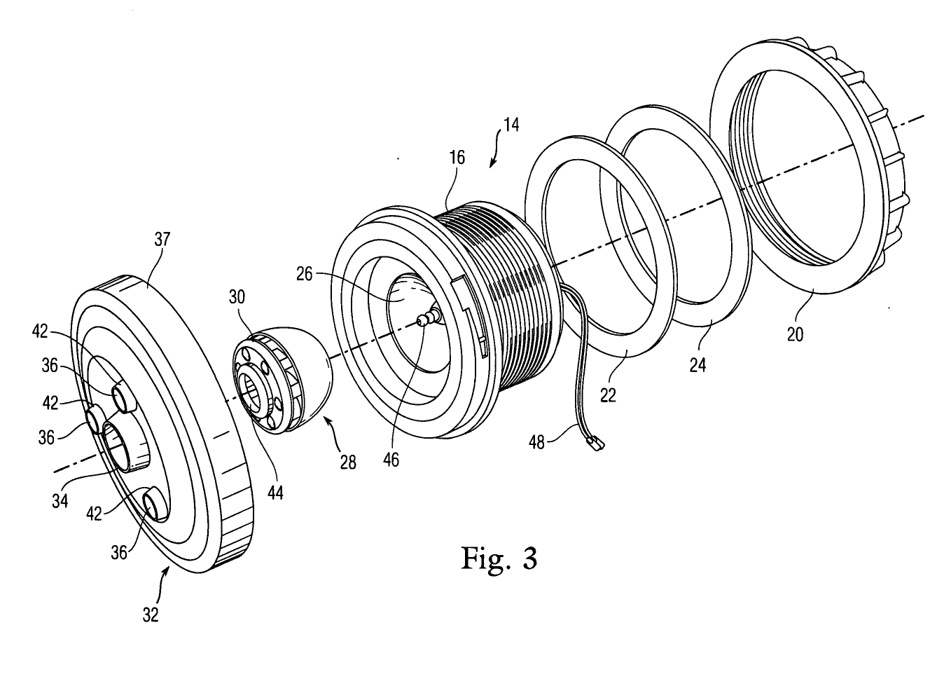

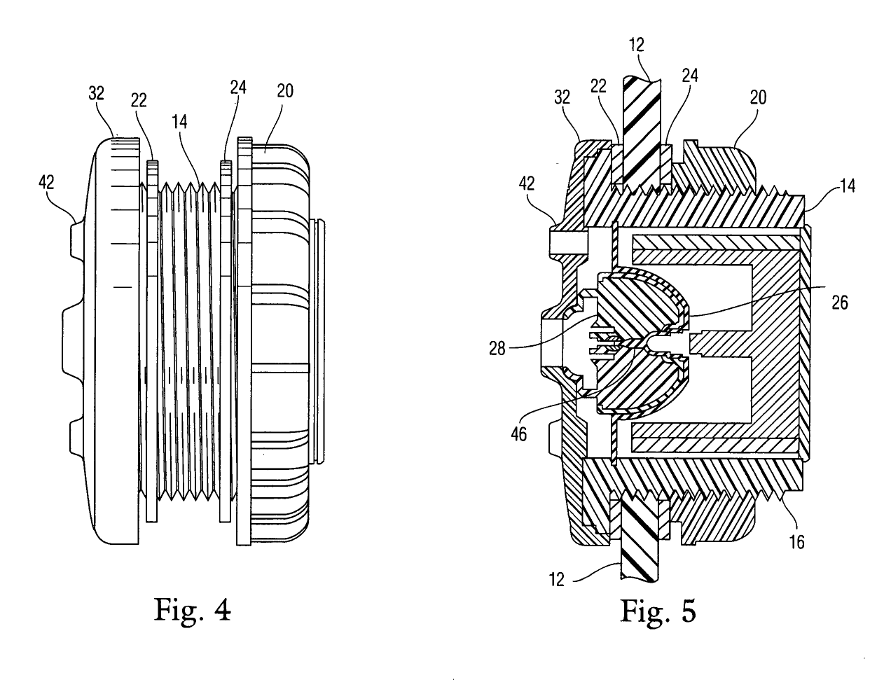

The jet pump of the present invention is shown in FIG. 3. As shown in FIGS. 4-5, a housing 14 has external threads 16 formed thereon. The first end of the housing has an enlarged shoulder 18. formed thereon. A cooperating threaded screw ring 20 is mounted on the threaded housing 14. A first seal ring 22 is disposed adjacent to the enlarged shoulder 18 on the housing and a second seal ring 24 is disposed adjacent to the screw ring 20. The basin 12 has an opening formed in the sidewall or bottom of the basin and the housing 14 is received in the opening with the seal rings 22, 24 on either side of the opening in the sidewall of the basin. Tightening of the screw ring 20 against the basin forms a watertight seal with the respective first seal ring 22 and second seal ring 24 between the basin and the housing. More than one jet pump may be mounted in the basin to provide more efficient circulation of water.

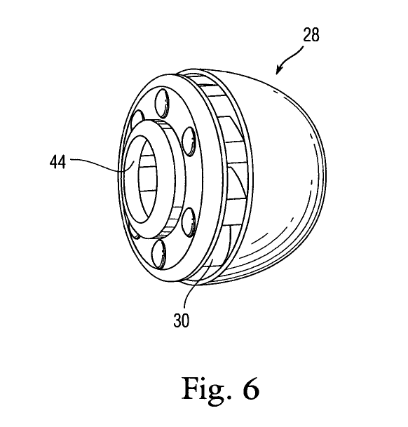

An induction motor is mounted in the housing 14. The induction motor has an electrically activated stator 26 and a permanent magnet rotor (FIG. 6). A motor which has been used satisfactorily is Model D4K-67 supplied by Laing Thermotech, Inc., San Diego, Calif. In a preferred embodiment, the stator has a well formed therein, the opening of the well being oriented toward the basin 12. The rotor has a semi-spherical shape which is received in the well in the stator 26. The rotor 28 may have a central bore 44 thereon and the well may have a post 46 formed centrally therein such that the rotor is always properly seated in the well. The motor has no propeller shaft. The motor has a lifetime in excess of 10,000 hours and is powered by direct current using up to 24V energy. The rotor 28 preferably has a plurality of vanes 30 formed circumferentially therein. When the motor is energized, water in the housing 14 is directed radially from the rotor 28 due to the rotation of the rotor and the vanes in the rotor.

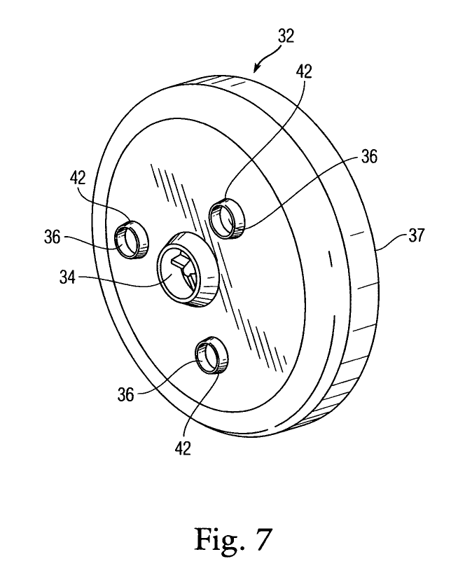

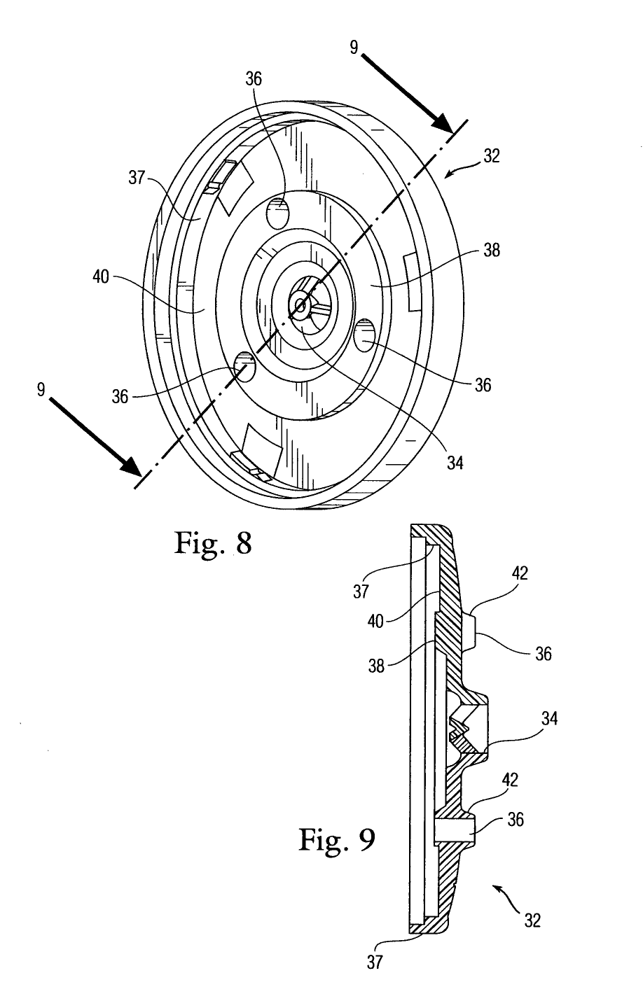

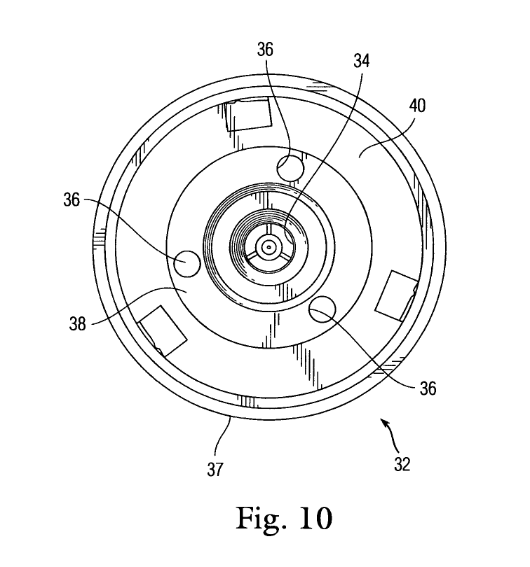

As shown in FIGS. 7-10, the cap 32 to the housing 14 is retained on the housing with a twist lock fitting for ease of manual attachment and removal. In the central portion of the cap 32, there is an opening 34 which serves as a water inlet. Also, there is at least one and preferably three equidistance spaced-apart, outlets 36 formed in the cap 32 outwardly of the inlet 34. An annular rim 37 is formed about the outer surface of the cap 32. The inner surface of the annular rim 37 defines the circumference of the inner surface of the cap 32. The inner surface of the cap 32 has a raised ring 38 formed thereon. The ring 38 is oriented toward the rotor 28 and surrounds the central portion and the water inlet opening 34. Between the raised ring 38 and the outer edge of the cap 32, there is formed a trepan 40. Further formed in the raised ring 38 there is at least one, and preferably three, openings which are the outlet ports 36 or discharge ports. In the embodiment with three outlets, it is preferred that the outlets are spaced apart 120° from one another. The outlet ports 26 pass through the caps 32 and, on the outer surface of the cap 32, there is a circumferential wall 42 around each outlet port 36 forming a respective nozzle.

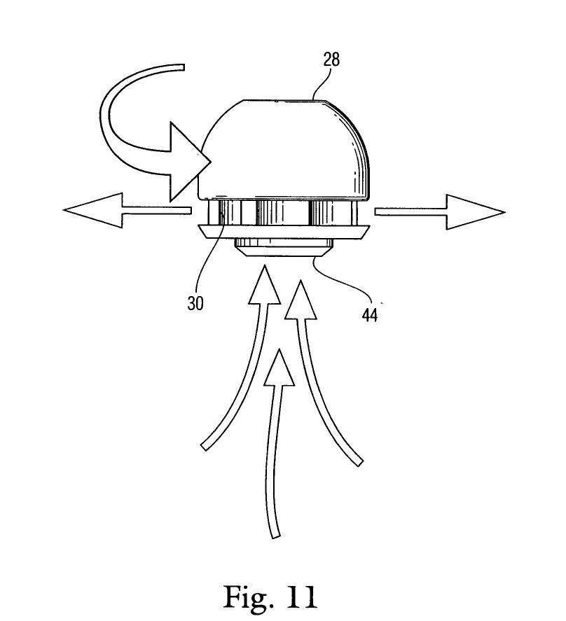

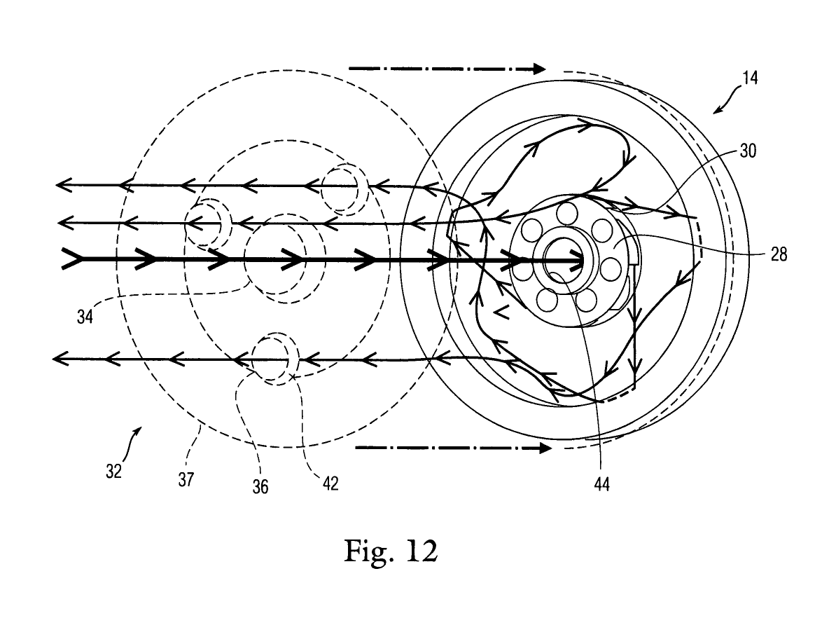

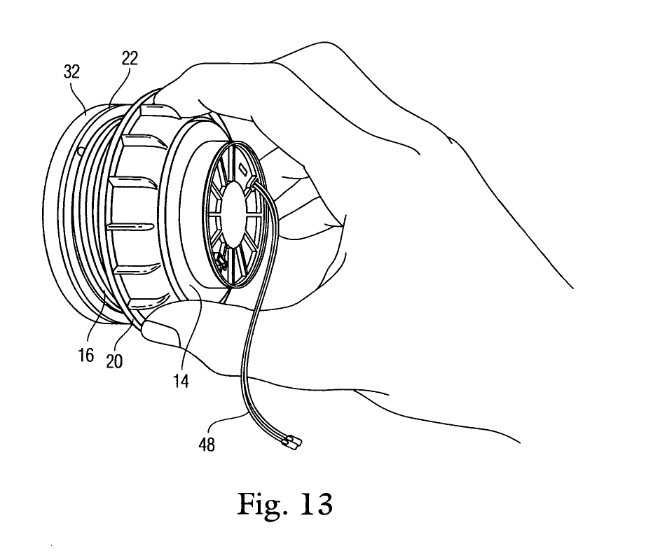

As shown in FIGS. 11-12, water within the basin 12 is drawn into the intake opening 34 in the center of the cap 32 by rotation of the rotor 28. The vanes in the rotor 28 expel the water radially across the trepan 40. The water is contained by the annular rim 37 and circulates within the cap 32 and is directed axially through the plurality of discharge port outlets 36. When leaving the outlets 36, the circumferential wall 42 on the outlet acts as a nozzle to forcefully direct the water into the basin 12 producing agitation, circulation and a whirlpool effect on the water within the basin.

The stator 26 is electrically connected to a low DC voltage power source using a quick-disconnect fitting 48. The stator 26 is in the housing 14 with the wiring on the opposite side from the rotor 28 and distal from the basin 12, Access to the wiring is through the back or side of the pedicure chair 10 permitting servicing of the motor (FIG. 12).

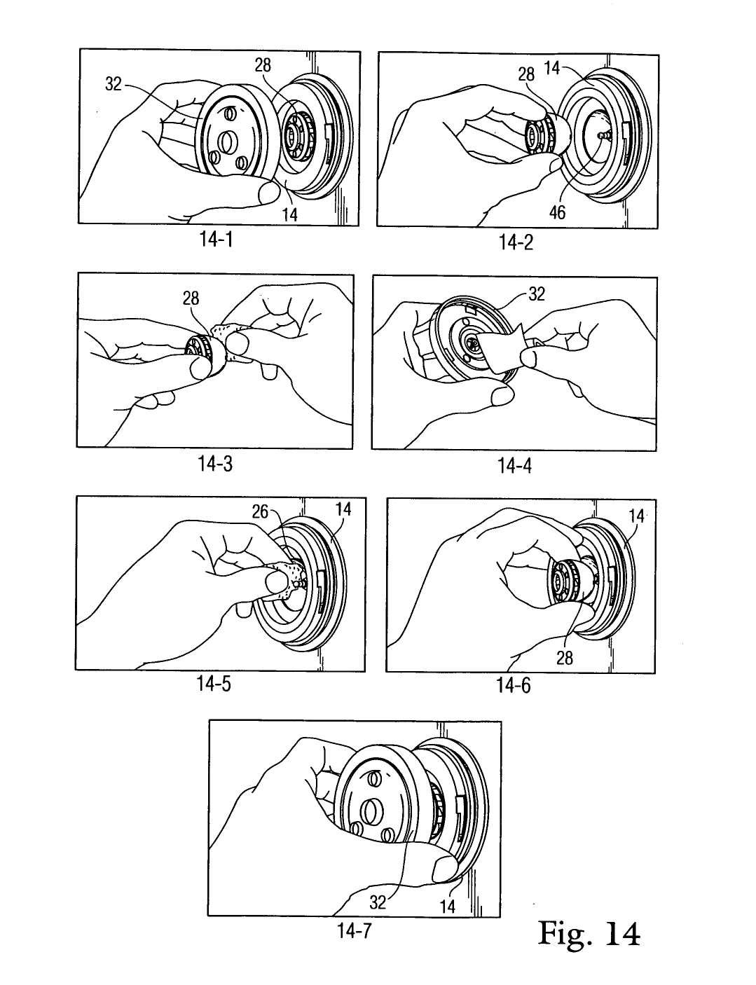

In a typical use (FIG. 14), the pedicure chair is prepared for a customer by manually twisting and removing the cap 32. The inner surface and outer surface of the cap 32 are wiped with a cloth/tissue having a sterilizing/cleaning material, such as alcohol, thereon. Alternately, the cap 32 may be immersed in a sterilizing/cleaning solution. The rotor 28 is manually removed from the stator 26 and cleaned/sterilized in a manner as performed with the cap 32. The stator 26 and the entire inner surface of the housing 14 are wiped with a cloth/tissue having a sterilizing/cleaning material thereon. The cleaned rotor 28 is replaced on the stator 26. Note that due to the magnetic nature of the rotor, it is strongly attracted to the stator. Simply disposing the rotor near the well in the stator is sufficient to have the rotor seat itself in the well with the post 46 in the well received in the bore 44 in the rotor. No tools or special handling are required. The cleaned cap is manually attached to the housing without the need for any tools. The interior of the basin is cleaned/sterilized by wiping with a cloth/tissue having a cleaning/sterilizing material thereon. A predetermined amount of water is placed in the basin. If desired, additional substances such as conditioners, medicaments, fragrances, etc. may be placed in the basin with the water. A customer is seated in the pedicure chair 10 with their feet oriented toward the at least one housing. The motor is activated to circulate the water in the basin and the water is circulated as required for the pedicure. After the 15 pedicure procedure is completed and the customer leaves, the basin is emptied of water and the basin, cap, rotor and interior of the housing and stator are sterilized/cleaned using the above described procedure. The cleaning/sterilizing procedure is completed in approximately one minute or less.

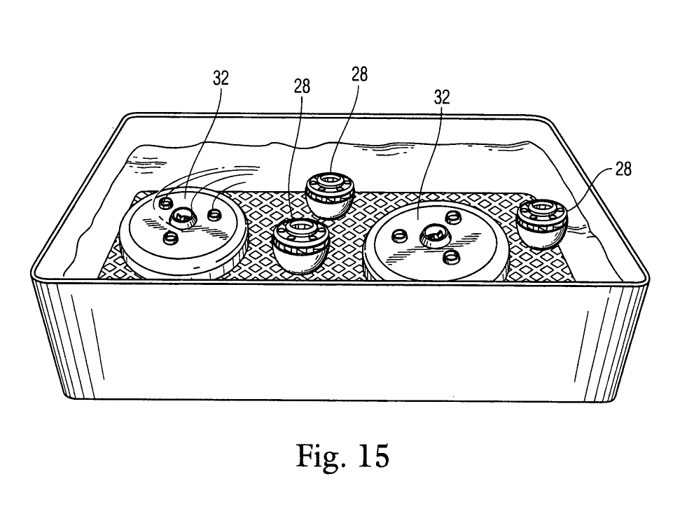

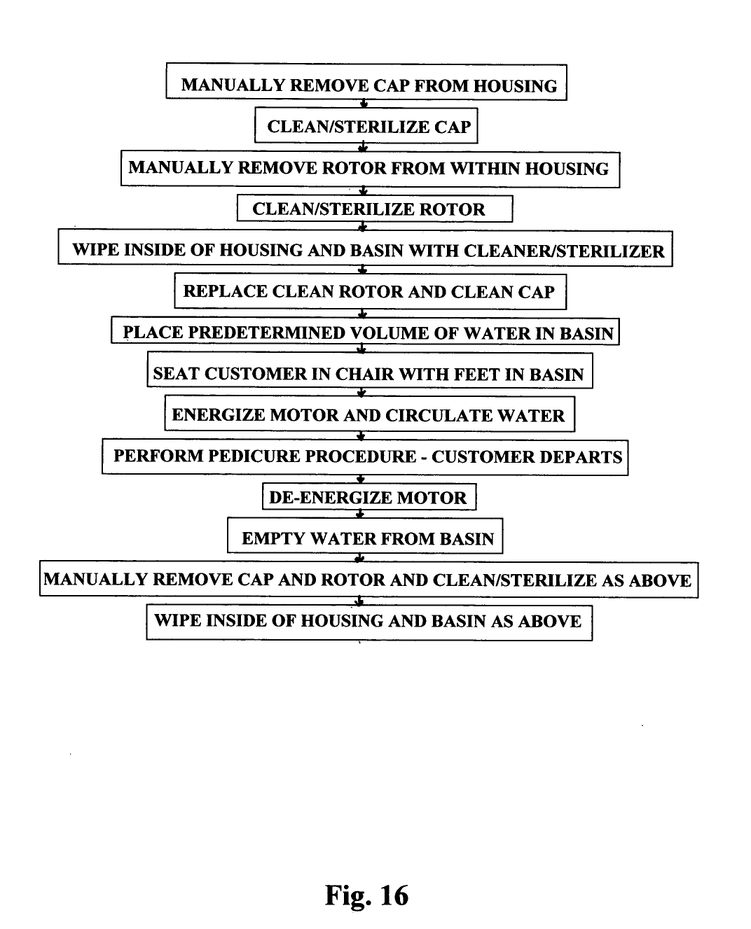

Alternately, there could be provided additional caps and rotors which are maintained in a cleaning/sterilizing bath or are kept in a cleaned/sterilized condition (FIG. 15). These clean components cold be used to replace the caps and/or rotors which are to be cleaned. This would further shorten the time to clean the pedicure chair for the next customer. A diagrammatic flowchart of use is presented in FIG. 16.

In the current state-of-the-art, the basin may be wiped with a cloth/tissue having a sterilizing/cleaning material, but is not possible to adequately clean the motor/fan used to circulate the water. Further, in the present chairs, there are pipes through which the water circulates and it is not possible to adequately clean these thoroughly. The absence of dirt, mold or bacteria in these pipes and/or on the motor/fan cannot be assured. Thus, in the present chairs, the alternatives are 1) do not sterilize/clean which can produce unsanitary, dermatological problems for customers, 2) conduct a partial cleaning which is inadequate, or 3) conduct a thorough cleaning which may require approximately 20 minutes and cannot assure the cleanliness of the pipes.

The present invention provides a method of using a pedicure chair which assures that the bath for the customer is safe and sanitary and which can be prepared in a relatively short time.

Although the above description is directed to a pedicure chair, the device may be used in a jacuzzi, whirlpool bath or similar item.

Obviously, many modifications may be made without departing from the basic spirit of the present invention. Accordingly, it will be appreciated by those skilled in the art that within the scope of the appended claims, the invention may be practiced other than has been specifically described herein.

What is claimed is:

1. In a pedicure chair having a whirlpool foot bath provided with a basin, wherein water is continually ejected through respective first pipes into the basin and is thereafter withdrawn therefrom through respective second pipes and wherein mold or bacteria may tend to accumulate in the pipes, such that cleaning or sterilizing the pipes after each customer becomes difficult and time consuming, and such that customer health problems or anxieties occur, the improvement comprising means for filling the basin with fresh water initially, at least one induction motor and combination pump mounted in a housing on the basin and having a removable cap provided with at least one inlet opening and at least one outlet opening for communication with the basin, such that the fresh water is sucked out of the basin through the inlet opening and thereafter is discharged out of the at least one outlet opening for continually recirculating the water in the basin and thereby creating a whirlpool action therein, the induction motor and combination pump having a stator and further having a magnetically-retained rotor; such that after each customer, the cap may be removed, the rotor manually pulled away from the stator, and the pump quickly and conveniently cleaned or sterilized; and such that, thereafter, the magnetically-retained motor and the cap may be easily replaced, thereby saving considerable time between customers, substantially improving customer safety, and removing customer anxieties and health concerns.

2. The improvement of claim 1, further comprising the removable cap having an inner surface and an outer surface, the inner surface having a raised ring formed thereon, the raised ring being oriented toward the rotor and having the at least one outlet opening formed therein, the outer surface of the cap having a circumferential wall formed about the at least one outlet opening, the wall extending outwardly from the top surface of the cap forming a nozzle thereon, such that water expelled radially from the rotor is directed axially through the at least one outlet and projected from the nozzle into the basin.

3. The improvement of claim 1, wherein three outlets are formed in the cap spaced equidistantly apart from one another.

4. The improvement of claim 1, further comprising the housing having a threaded outer wall, an enlarged shoulder on a first end of the housing, and a threaded screw ring, the threads on the outer wall cooperating with the threads on the screw ring, the basin having an opening formed therein, wherein the housing is received in the opening in the basin, a first seal ring being disposed between the shoulder on the housing and the opening in the basin, a second seal ring being disposed between the screw ring and the opening in the basin, wherein tightening of the screw ring forms a watertight seal between the housing and the basin.

5. The improvement of claim 1, wherein two induction motors and combination pumps are mounted on a sidewall of the basin.

6. The improvement of claim 1, wherein the induction motor is powered by direct current, nominally up to 24V.

7. A jet pump mounted in a basin of a pedicure chair, jacuzzi or whirlpool bath wherein water is circulated, the jet pump comprising:
a housing having an externally accessible removable cap, the cap having an outer surface and an inner surface, an annular rim formed on the outer surface, a raised ring formed in the inner surface separated from the annular rim by a trepan, a central portion being defined within the raised ring, the central portion having a water inlet formed therein, the raised ring having a plurality of discharge ports formed therein, the discharge ports extending through the cap,
a motor having a stator and a magnetically coupled rotor disposed within the housing, the rotor being received within the central portion of the cap,
wherein when the motor is activated, the rotor rotates drawing water through the water inlet and expelling the water radially across the trepan, the water circulating within the cap and being directed axially outwardly through the plurality of discharge ports.

8. The jet pump of claim 7, wherein there are three discharge ports spaced 120° apart from one another.

9. The jet pump of claim 7, wherein each of the plurality of discharge ports has a circumferential wall formed on the outer surface of the cap extending outwardly therefrom forming a respective nozzle to forcefully eject the water.

10. The jet pump of claim 7, wherein the motor is a direct current motor.

11. The jet pump of claim 10, wherein the motor operates on 24V.

12. The jet pump of claim 7, wherein the rotor is manually removable from the stator.

13. The jet pump of claim 7, wherein the cap has a twist lock connection to the housing.

14. The jet pump of claim 7, wherein the housing is externally threaded, a cooperating threaded screw ring is mounted on the threaded housing, a first seal ring being disposed adjacent to the screw ring, a second seal ring being disposed adjacent to a shoulder formed on a first end of the housing such that the housing may be mounted with a watertight seal on the basin of a pedicure chair, jacuzzi or whirlpool bath by tightening the screw ring.

15. A method of preparing a pedicure bath for use and of using the bath comprising the steps of:
providing a chair having a whirlpool foot bath with a basin in which a customer's feet are disposed, the basin having at least one pump therein, the at least one pump having a housing and a removable cap, the cap having at least one inlet opening and at least one outlet opening formed therein, a motor received in the housing, the motor having a stator and a magnetically retained rotor wherein the rotor may be manually lifted out of the housing without the use of tools, wherein when the motor is activated, water in the basin is drawn into the at least one inlet opening and discharged vigorously from the at least one outlet creating a whirlpool action and circulating water in the basin,
placing a predetermined amount of water in the basin,
seating a customer in the chair wherein the customer's feet are aligned with the at least one pump,
activating the pump for a predetermined time,
removing the customer's feet from the basin and emptying the water from the basin,
removing the cap from the housing of the pump and manually removing the rotor, cleaning and sterilizing the cap and rotor and stator of the motor, replacing the rotor and the cap,
cleaning and sterilizing the basin,
wherein the foot bath is prepared for the next customer in a safe, sanitary and rapid manner.
